(19) United States
(12) Patent Application Publication
(10) Pub. No.: US 2015/0022025 A1
(43) Pub. Date: Jan. 22, 2015

(54) SMART ENERGY-SAVING POWER SOURCE CONTROL APPARATUS AND METHOD

(71) Applicant: NATIONAL CHENG KUNG UNIVERSITY, TAINAN CITY (TW)

(72) Inventors: SEN-YUNG LEE, TAINAN CITY (TW); JYUN-YAN ZENG, TAINAN CITY (TW); YIH-RAN SHEU, TAINAN CITY (TW)

(73) Assignee: NATIONAL CHENG KUNG UNIVERSITY, TAINAN CITY (TW)

(21) Appl. No.: 14/029,947

(22) Filed: Sep. 18, 2013

(30) Foreign Application Priority Data
Jul. 16, 2013 (TW) 102125329

(51) Int. Cl. H01H 9/54

(52) U.S. Cl. CPC H01H 9/54
USPC 307/116

(57) ABSTRACT

The present invention discloses a smart energy-saving power source control apparatus and method. The apparatus includes a sensor set and a system control unit, and the system control unit includes a moving direction determination unit, a timer, a counter, a power switch system control unit. The method includes the steps of: electrically connecting the moving direction determination unit to the direction sensor set to detect and determine the moving direction and the number of persons; defining an initial value for a numeric value of the counter, and setting a set time for the timer; incrementing the numeric value of the counter by one unit if the moving direction determination unit detects the entrance of a person, and starting counting time by the timer; decrementing the numeric value of the counter by one unit if a person exits; turning off the power switch system control unit if the numeric value of the counter is equal to the initial value; turning on the power switch system control unit if the numeric value of the counter is greater than the initial value; compulsorily resetting the counter to the initial value if the time counted by the timer is equal to the set time value and turning off the power switch system control unit, and resetting the timer and stopping counting the time. The apparatus is installed in an indoor space such as a conference room, an office, a research room, a public bathroom or a pantry with one or more exits. The invention automatically controls the switch of power without requiring any manual operation, not only capable of determining whether there is people in a controlled space, but also capable of self-correcting and removing noises to achieve the smart energy-saving effect and improve the convenience and safety of use.

### FIELD OF THE INVENTION

The present invention relates to a smart energy-saving power source control apparatus and method, and more particularly to the smart energy-saving power source control apparatus and method capable of determining whether or not there is any person in a controlled space to automatically control a power switch and provides the self correction and noise elimination functions without requiring users to operate the power switch, so as to achieve the smart energy-saving effect and improve the users' convenience and safety, such that the present invention can be installed in an indoor space a conference room, an office, a research room, a public bathroom or a pantry with one or more exits.

### BACKGROUND OF THE INVENTION

In recent years, environmental protection and power saving become increasingly more important, and different countries promote people to readily turn off the electric appliances that are not in use in order to reduce the consumption of electric power and achieve the power saving and carbon reduction effects. However, public places such as meeting rooms, offices, researches rooms and public bathrooms have lamps that will not be turned off actively after their use by the public. Regardless of being used or not used, the lamps of the aforementioned public places are always on, thus wasting unnecessary electric power.

Therefore, an infrared sensing lamp switch as shown in FIG. 1 was introduced to the market, and the switch comprises an infrared sensor 20 installed at an outer door 101 of a bathroom 10 and electrically coupled to a system control unit 30, wherein the system control unit 30 is coupled to a timer 301 and a lamp 302 installed in the bathroom 10, and the timer 301 has a predetermined value, and is coupled to the lamp 302, so that when the infrared sensor 20 is triggered, the system control unit 30 transmits a control signal to the timer 301 and lamp 302 to turn on the lamp 302 and drive the timer 301 to starting counting time. Until the time counted by the timer 301 is equal to a predetermined value, the timer 301 will turn off the lamp 302. For example, the predetermined value can be set to 3 minutes. In other words, the lamp 302 will be triggered by the infrared sensor 20 and turned on for 3 minutes, and then the lamp 302 will be turned off automatically, regardless of whether or not there is a person entering or exiting the bathroom 10, so as to save the power when no one is in the bathroom 10 and achieve the power saving and carbon reduction effects.

However, if the predetermined value is set to 3 minutes and people such as critically ill patents, elderly, and infirm take a longer time for the bathroom, the three-minute predetermined time set for the lamp 302 is obviously insufficient. Users may have fear while they are using the bathroom and the lamp 302 is turned off automatically after the timer 301 has counted time for 3 minutes, or even worse accidents may occur due to the poor vision without light. If the predetermined value is set to 10 minutes, the time may be too long, thus resulting in a waste of electric power of the lamp 302. In addition, when a user leaves the bathroom, the infrared sensor will be triggered again, so that the lamp 302 further wastes electric power. For a long period of time, the cost for the wasted electric power will be accumulate to a considerable amount, and the waste of power is incompliant to the idea of power saving and carbon reduction.

In view of the aforementioned problem, the inventor of the present invention based on the conventional infrared sensing lamp switch to conduct researches and experiments, and finally invented the present invention to overcome the problems of the prior art.

### SUMMARY OF THE INVENTION

Therefore, it is a primary objective of the present invention to overcome the aforementioned problems and avoid unnecessary waste of electric power by providing a smart energy-saving power source control apparatus and method, and the smart energy-saving power source control apparatus and method comprise a sensor set and a system control unit, wherein the sensor set is coupled to the system control unit, and the system control unit includes a moving direction determination unit, a timer, a counter and a power switch system control unit; and the method comprises the steps of: defining a numeric value of the counter as an initial value, and setting a set time in the timer; incrementing the numeric value of the counter by a unit when the moving direction determination unit detects the entrance of a person, and starting timing by the timer; and decrementing the numeric value of the counter by a unit when a person exits; turning off the power switch system control unit when the numeric value of the counter is equal to the initial value; and turning on the power switch system control unit when the numeric value of the counter is greater than the initial value; and compulsorily resetting the counter to the initial value when the time counted by the timer is equal to the set time, so as to turn off the power switch system control unit, reset the timer, and stop timing; thereby, the smart energy-saving power source control apparatus can be installed in an indoor space with one or more exits, and the indoor space is a conference room, an office, a research room, a public bathroom or a pantry, and the smart energy-saving power source control apparatus is capable of determining whether there is a person in the controlled space, automatically controlling the function of the power switch, and providing self correction and noise elimination the functions without requiring a manual operation of the power switch, so as to achieve a smart energy-saving effect and enhance the convenience and safety of users.

In the smart energy-saving power source control apparatus and method, the sensor set is a direction sensor set coupled to the moving direction determination unit and the counter for recognizing and calculating the number of entering/exiting persons.

In the smart energy-saving power source control apparatus and method, the direction sensor set is an assembly selected from the group of an infrared sensor, a light shielding device, a temperature sensor, a camera, an image recognition device and a microwave recognition device, and if the width of the outer door of the indoor space only allows one person to enter or exit at a time, the direction sensor set can have two infrared sensors; if the width of the outer door allows a plurality of persons to enter or exit at the same time, the direction sensor set can be an assembly with two infrared sensors and a camera or another image recognition device; and the moving direction determination unit determines an entering/exiting direction of a person according to a sensing order of the direction sensor set, and determines the number of entering/exiting persons according to the image recognition device.

In the smart energy-saving power source control apparatus and method, the direction sensor set with the image recognition function is capable of identifying the number of persons and the moving direction at the same time.

The smart energy-saving power source control apparatus and method further comprise a substep of determining whether there is a person in the indoor space to automatically control the power switch design, and the substep comprises: setting a numeric value of the counter as an initial value; incrementing the numeric value of the counter by a unit when the moving direction determination unit detects the entrance of a person, and starting timing by the timer; and decrementing the numeric value of the counter by a unit when a person exits; and turning off the power switch system control unit when the numeric value of the counter is equal to the initial value, and turning on the power switch system control unit when the numeric value of the counter is unequal to the initial value.

The smart energy-saving power source control apparatus and method further comprise a substep with a self correction and noise elimination design, and the substep comprises: setting a set time for the timer; starting timing when the direction sensor set of the first order is triggered in an entering direction; and compulsorily resetting the counter to the initial value when the time counted by the timer is equal to the set time, so as to turn off the power switch system control unit, reset the timer, and stop timing.

With the aforementioned structure, the present invention can be installed in an indoor space such as a conference room, an office, a research room, a public bathroom or a pantry with one or more exits. When the numeric value of the counter is greater than the initial value, the power switch control unit is turned on, and after the counter resets the initial value, the power switch control unit is turned off. The present invention automatically controls the switch of power without requiring any manual operation, not only capable of determining whether there is people in a controlled space, but also capable of self-correcting and removing noises to achieve the smart energy-saving effect and improve the convenience and safety of use. The invention also can automatically break the power supply circuit to achieve the power saving, carbon reduction, smart energy saving and safety effects. In addition, the present invention comes with a simple circuit without requiring a complicated circuit layout, so that the aesthetic look of the indoor space can be maintained without ruining the decoration. Further, the present invention employs the timer capable of still counting time to the set time, so as to compulsorily reset the counter to the initial value, even when the moving direction determination unit or the direction sensor set is triggered by accident. Therefore, the system control unit can periodically performs the self correction and noise elimination to achieve the smart energy-saving effect.

### BRIEF DESCRIPTION OF THE DRAWINGS

FIG. 1 is a schematic view of the structure of a conventional infrared sensing lamp switch;

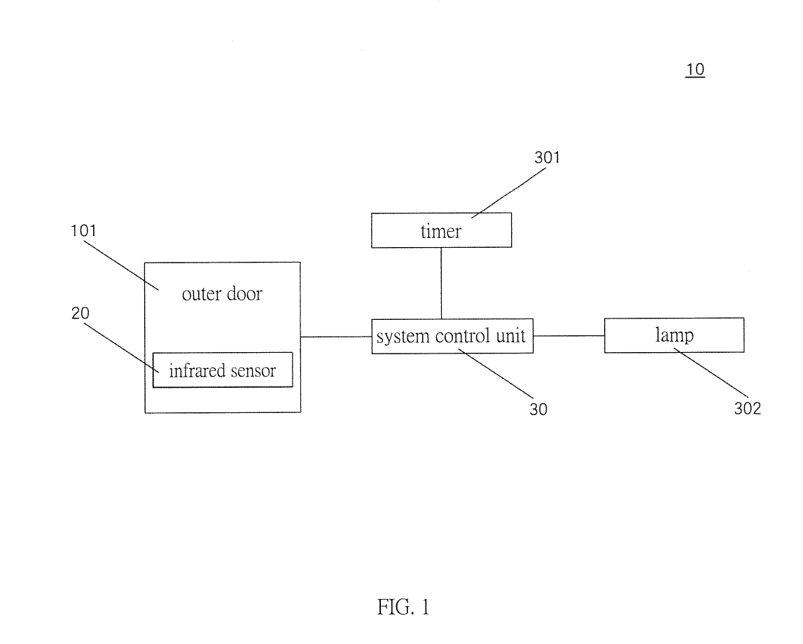

FIG. 2 is a flow chart of the present invention; and

FIG. 3 is a schematic view of a person entering into an indoor space in accordance with a first preferred embodiment of the present invention;

FIG. 4 is a schematic view of a person wandering around but not entering into an indoor space in accordance with the first preferred embodiment of the present invention;

FIG. 5 is a schematic view of an indoor space in accordance with a second preferred embodiment of the present invention;

FIG. 6 is a side view of a base in accordance with a third preferred embodiment of the present invention;

FIG. 7 is a schematic view of an indoor space in accordance with the third preferred embodiment of the present invention;

FIG. 8 is a side view of a base in accordance with a fourth preferred embodiment of the present invention; and

FIG. 9 is a schematic view of an indoor space in accordance with a fifth preferred embodiment of the present invention.

### DESCRIPTION OF THE PREFERRED EMBODIMENTS

The technical characteristics, contents, advantages and effects of the present invention will be apparent with the detailed description of a preferred embodiment accompanied with the illustration of related drawings as follows.

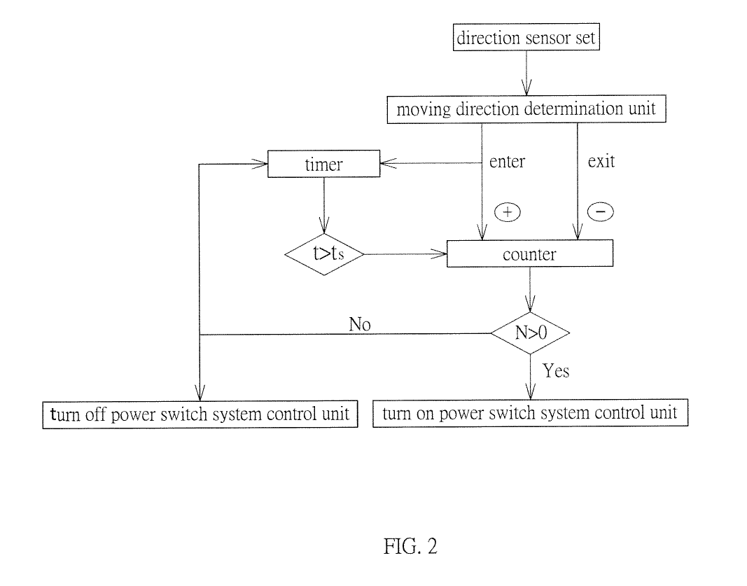

With reference to FIGS. 2 to 4 for a smart energy-saving power source control apparatus and method in accordance with the first preferred embodiment of the present invention, the smart energy-saving power source control apparatus and method comprise a sensor set which is a direction sensor set 1 and a system control unit 2, and the sensor set is coupled to the system control unit 2, and the system control unit 2 includes a moving direction determination unit 21, a timer 22, a counter 23 and a power switch system control unit 3. The direction sensor set 1 is coupled to the moving direction determination unit 21 and the counter 23 for identifying and calculating the number of entering/exiting persons. The direction sensor set 1 is an assembly selected from the group of an infrared sensor, a light shielding device, a temperature sensor, a camera, an image recognition device 11 and a microwave recognition device. The method comprises the steps of:

defining a numeric value of the counter 23 as an initial value, and setting a set time for the timer 22;

incrementing the numeric value of the counter 23 by a unit when the moving direction determination unit 21 detects the entrance of a person, and starting timing by the timer 22; and decrementing the numeric value of the counter 23 by a unit when a person exits:

turning off the power switch system control unit 3 when the numeric value of the counter 23 is equal to the initial value; and turning on the power switch system control unit 3 when the numeric value of the counter 23 is greater than the initial value; and

compulsorily resetting the counter 23 to the initial value when the time counted by the timer 22 is equal to the set time, so as to turn off the power switch system control unit 3, reset the timer 22, and stop timing;

thereby, the smart energy-saving power source control apparatus can be installed in an indoor space with one or more exits, and the indoor space is a conference room, an office, a research room, a public bathroom or a pantry, and the smart energy-saving power source control apparatus is capable of determining whether there is a person in the controlled space, automatically controlling the function of the power switch, and providing self correction and noise elimination the functions without requiring a manual operation of the power switch, so as to achieve a smart energy-saving effect and enhance the convenience and safety of users.

If the width of the outer door 41 of the indoor space 4 only allows one person to enter or exit, then the direction sensor set 1 can be one including two infrared sensors.

The present invention further comprises a substep of determining whether there is a person in the indoor space 4 to automatically control the power switch design, and the substep comprise the steps of: setting a numeric value of the counter 23 as an initial value; incrementing the numeric value of the counter 23 by a unit when the moving direction determination unit 21 detects the entrance of a person, and starting timing by the timer 22; and decrementing the numeric value of the counter 23 by a unit when a person exits; and turning off the power switch system control unit 3 when the numeric value of the counter 23 is equal to the initial value, and turning on the power switch system control unit 3 when the numeric value of the counter 23 is unequal to the initial value.

The present invention further comprises a substep with the design of self correction and noise elimination, and the substep comprises: setting a set time for the timer 22; starting timing when the direction sensor set 1 of the first order is triggered in an entering direction; and compulsorily resetting the counter 23 to the initial value when the time counted by the timer 22 is equal to the set time, so as to turn off the power switch system control unit 3, reset the timer 22, and stop timing.

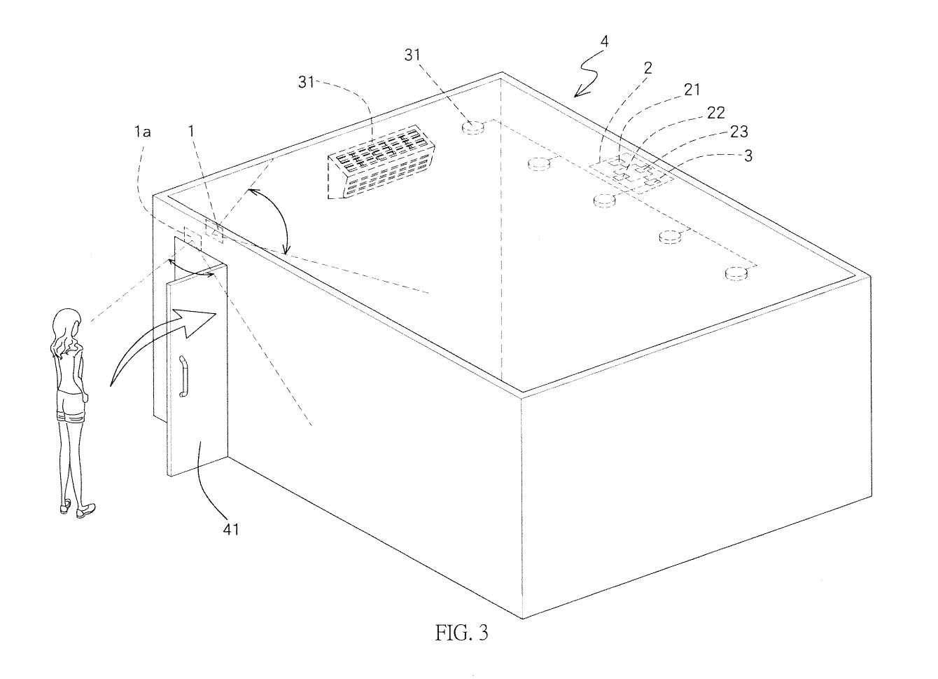

With reference to FIGS. 2 and 3 for an operating status in accordance with a preferred embodiment of the present invention, the present invention can be installed in an indoor space 4, and the indoor space 4 has an outer door 41, and the direction sensor set 1 is installed at an end of the outer door 41, so that when a person enters into the indoor space 4 from the outer door 41, the direction sensor set 1 is triggered to deter wine the entering or exiting direction of the person, so as to increment or decrement the counter 23 by a unit. For example, if the initial value of the counter 23 is set to 0, and the unit is 1, and the moving direction determination unit 21 determines that a person has entered, then the numeric value N of the counter 23 will be incremented from 0 to 1. If another person has entered, then the numeric value N of the counter 23 will be incremented from 1 to 2. On the other hand, if a person has exited, then the numeric value N of the counter 23 will be decremented by 1, so that if the numeric value N of the counter 23 is greater than the initial value (which is equal to 0 in this preferred embodiment), the power switch system control unit 3 will be turned on. Until the persons in the indoor space 4 have exited one by one and the numeric value N of the counter 23 is equal to initial value, the power switch system control unit 3 will be turned off. In addition, if there is no person in the indoor space 4, the automatic control design of the power switch turns on the power switch system control unit 3 when the numeric value N of the counter 23 is unequal to initial value. Therefore, the power switch system control unit 3 of the present invention can maintain the power-on for the convenience and safety of a user, even if the user takes a longer time in the indoor space 4. After the numeric value N of counter 23 is reset to the initial value before turning off the power switch system control unit 3. Therefore, when there is no one in the indoor space 4, only the power required for the operation of the direction sensor set 1 is maintained to avoid a continuous consumption of the electric power. If the direction sensor set is an infrared sensor, the passive sensing of the infrared sensor will not waste any electric power for the idling. As a result, the present invention does not waste any power for the idling of an electric appliance 31 such as an air-conditioner connected to the power switch system control unit 3, so as to reduce the consumption of the electric power significantly and achieve the smart energy-saving effect.

To prevent the power source control apparatus of the present invention from being triggered by accident such as an animal triggering the direction sensor set 1 by accident or two persons trigger the direction sensor set 1 as the same time (an adult carrying a child and entering in the same direction), the numeric value N of the counter 23 is incremented by 2. However, the adult holding the child in his/her arms exits the indoor space 4, the numeric value N of the counter 23 is decrement by 1 only, so that the power switch system control unit 3 will be remained on continuously and will result in a waste of electric power. Now, if the moving direction determination unit 21 determines that a person has entered, the timer 22 will start timing. After the time t counted by the timer 22 is equal to the set time ts, the counter 23 is compulsorily reset to the initial value, and power switch system control unit 3 is turned off, so as to prevent an accident trigger and achieve the energy saving effect effectively.

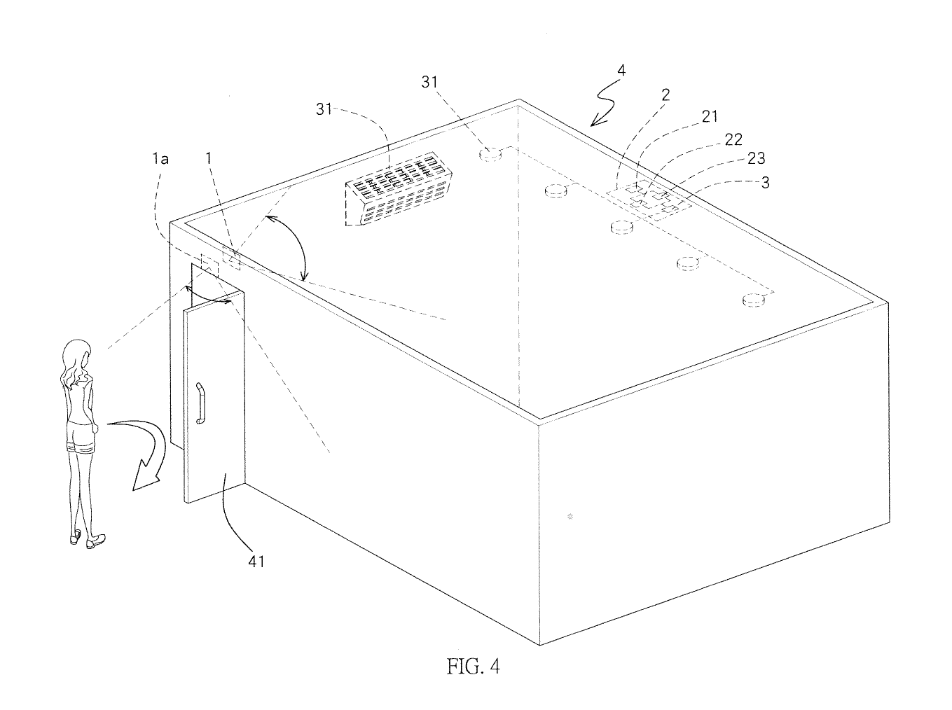

To turn on the power switch system control unit 3 timely to provide a good vision. the present invention turns on the power switch system control unit 3 immediately after the first-order direction sensor set 1a (which is the direction sensor set 1 at an end opposite to the indoor space 4a in the entering direction is triggered as shown in FIG. 4. However, if the person just wanders around the outer door 41 without entering the outer door 41, the first-order direction sensor set 1a in the entering direction is triggered the timer 22 will start timing. After the time counted by the timer 22 is equal to the set time, the power switch system control unit 3 will be turned off compulsorily to prevent the present invention from being triggered by accident or misjudged, so as to achieve the smart energy-saving effect effectively.

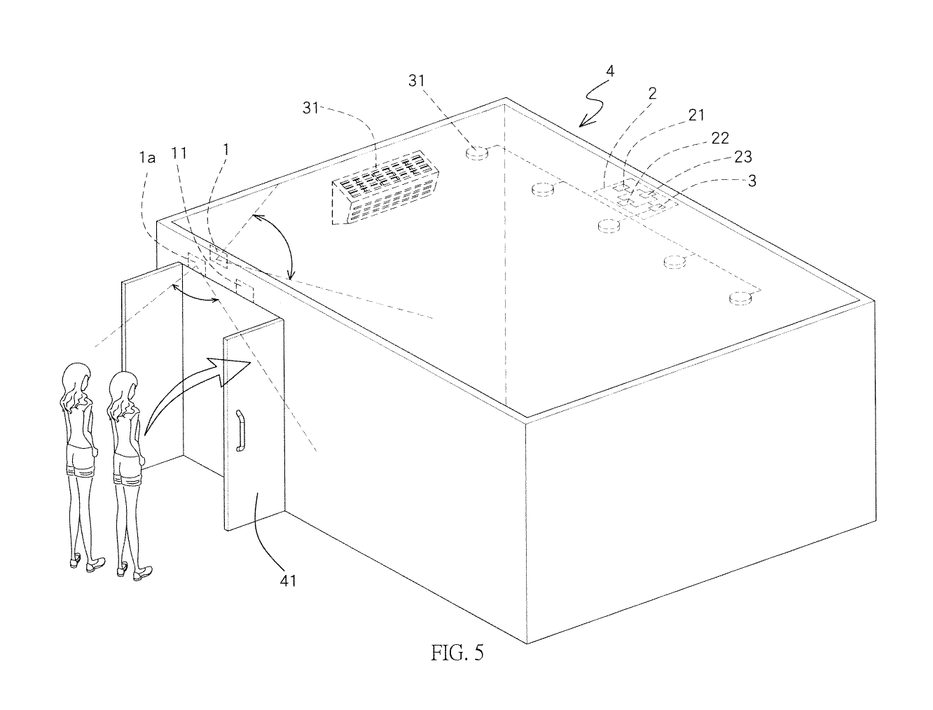

With reference to FIG. 5 for a second preferred embodiment of the present invention, the difference of this preferred embodiment from the first preferred embodiment resides on that if the width of the outer door 41 allows a plurality of persons to enter at the same time, then the direction sensor set 1 can be an assembly including two infrared sensors and a camera or another image recognition device 11, and the moving direction determination unit 21 determines the entering/exiting direction of a person according to the sensing order of the direction sensor set 1 and the number of persons according t the image recognition device 11, and the direction sensor set 1 with an image recognition function can recognize the number of persons and the moving direction, so that if two persons enter at the same time, then the numeric value Na of the counter 23 will be incremented by 2, and if three persons enter at the same time, the numeric value N of the counter 23 will be incremented by 3, and so forth. On the other hand, the same applies to the exiting direction. Therefore, the scope of applicability of the present invention can be broadened. It is noteworthy that the operation method of this preferred embodiment is similar to that of the previous preferred embodiment, and thus will not be repeated.

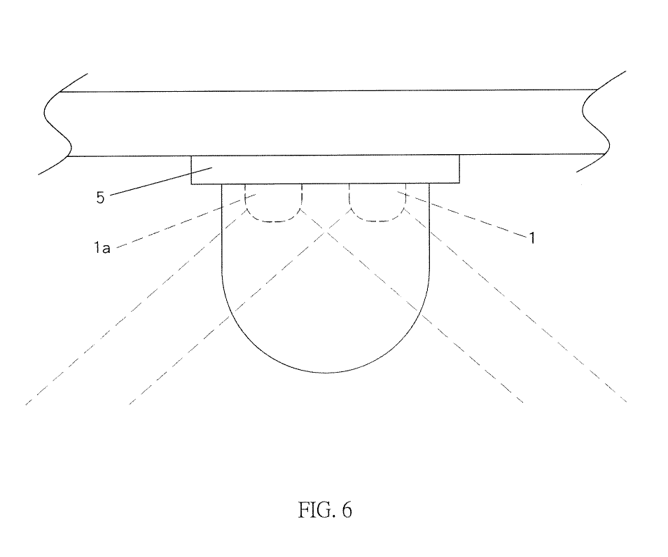

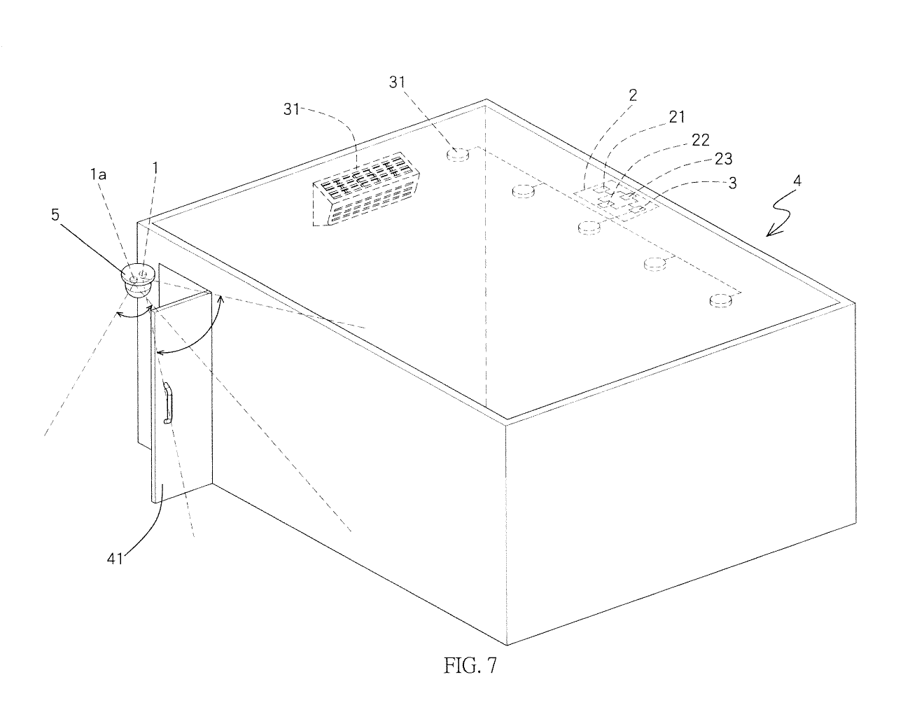

With reference to FIGS. 6 and 7 for a third preferred embodiment of the present invention, the difference of this preferred embodiment from the first preferred embodiment resides on that the direction sensor set 1 is not installed separately, but is installed on a base 5 to simplify the circuit layout and maintain the aesthetic look of the indoor space 4 and the convenience of maintenance. It is noteworthy that the operation method of this preferred embodiment is similar to that of the previous preferred embodiment, and thus will not be repeated.

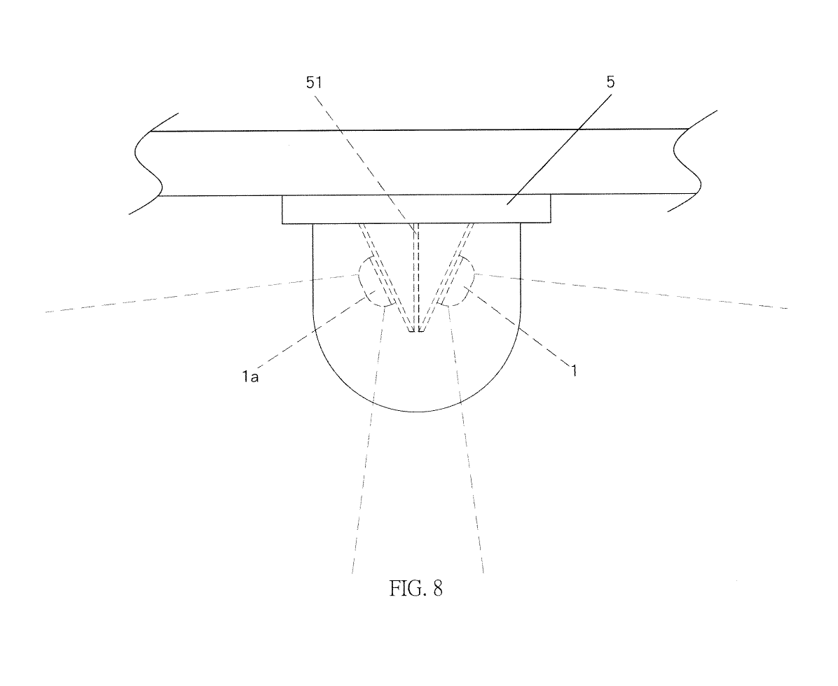

With reference to FIG. 8 for a fourth preferred embodiment of the present invention, the difference of this preferred embodiment from the third preferred embodiment resides on that the base 5 further includes an isolating device 51 disposed within the direction sensor set 1 to enhance the precision and recognition capability of the direction sensor set 1 to prevent the interference between sensors of the direction sensor set 1 which may affect the determination. It is noteworthy that the operation method of this preferred embodiment is similar to that of the previous preferred embodiment, and thus will not be repeated.

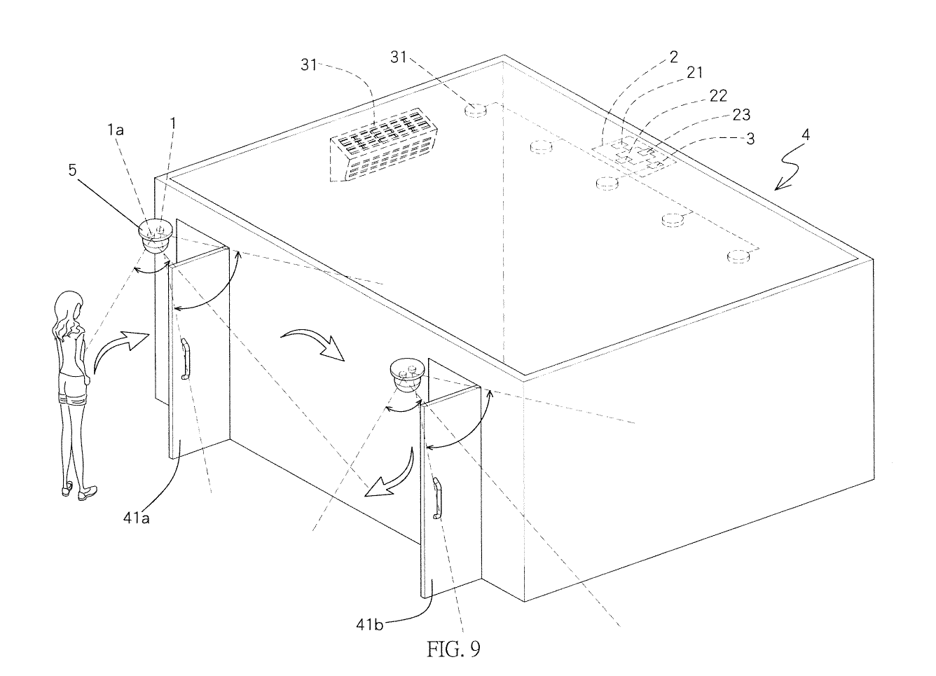

With reference to FIG. 9 for a fifth preferred embodiment of the present invention, the difference of this preferred embodiment from the first preferred embodiment resides on that the indoor space 4 has two outer doors 41, and the moving direction determination unit 21 is coupled to the two direction sensor sets 1, and the direction sensor set 1 is installed on an end of each outer door 41, so that a person can enter or exit from any one of the outer doors 41, and the counter 23 and the timer 22 can be operated to turn on or off the power switch system control unit 3. For example, if a person enters from the outer door 41a, then the numeric value N of the counter 23 will be incremented by 1. If a person exits from the outer door 41b, the numeric value N of the counter 23 will be decremented by 1, so that the present invention can improve the scope of applicability and can be used for various different indoor spaces 4. It is noteworthy that the operation method of this preferred embodiment is similar to that of the previous preferred embodiment, and thus will not be repeated.

What is claimed is:

1. A smart energy-saving power source control apparatus and method, comprising a sensor set and a system control unit, and the sensor set being coupled to the system control unit, and the system control unit including a moving direction determination unit, a timer, a counter and a power switch system control unit; and
the method comprising the steps of:
defining a numeric value of the counter as an initial value, and setting a set time in the timer;
incrementing the numeric value of the counter by a unit when the moving direction determination unit detects the entrance of a person, and starting timing by the timer; and decrementing the numeric value of the counter by a unit when a person exits;
turning off the power switch system control unit when the numeric value of the counter is equal to the initial value; and turning on the power switch system control unit when the numeric value of the counter is greater than the initial value; and
compulsorily resetting the counter to the initial value when the time counted by the timer is equal to the set time, so as to turn off the power switch system control unit, reset the timer, and stop timing;
thereby, the smart energy-saving power source control apparatus can be installed in an indoor space with one or more exits, and the indoor space is a conference room, an office, a research room, a public bathroom or a pantry, and the smart energy-saving power source control apparatus is capable of determining whether there is a person in the controlled space, automatically controlling the function of the power switch, and providing self correction and noise elimination the functions without requiring a manual operation of the power switch, so as to achieve a smart energy-saving effect and enhance the convenience and safety of users.

2. The smart energy-saving power source control apparatus and method as claimed in claim 1, wherein the sensor set is a direction sensor set coupled to the moving direction determination unit and the counter for recognizing and calculating the number of entering/exiting persons.

3. The smart energy-saving power source control apparatus and method as claimed in claim 2, wherein the direction sensor set is an assembly selected from the group of an infrared sensor, a light shielding device, a temperature sensor, a camera, an image recognition device and a microwave recognition device, and if the width of the outer door of the indoor space only allows one person to enter or exit at a time, the direction sensor set can have two infrared sensors; if the width of the outer door allows a plurality of persons to enter or exit at the same time, the direction sensor set can be an assembly with two infrared sensors and a camera or another image recognition device; and the moving direction determination unit determines an entering/exiting direction of a person according to a sensing order of the direction sensor set, and determines the number of entering/exiting persons according to the image recognition device.

4. The smart energy-saving power source control apparatus and method as claimed in claim 3, wherein the direction sensor set with the image recognition function is capable of identifying the number of persons and the moving direction at the same time.

5. The smart energy-saving power source control apparatus and method as claimed in claim 1, further comprising a substep of determining whether there is a person in the indoor space to automatically control the power switch design, and the substep comprising:
setting a numeric value of the counter as an initial value;
incrementing the numeric value of the counter by a unit when the moving direction determination unit detects the entrance of a person, and starting timing by the timer; and decrementing the numeric value of the counter by a unit when a person exits; and
turning off the power switch system control unit when the numeric value of the counter is equal to the initial value, and turning on the power switch system control unit when the numeric value of the counter is unequal to the initial value.

6. The smart energy-saving power source control apparatus and method as claimed in claim 1, further comprising a substep with a self correction and noise elimination design, and the substep comprising: setting a set time for the timer;
starting timing when the direction sensor set of the first order is triggered in an entering direction; and compulsorily resetting the counter to the initial value when the time counted by the timer is equal to the set time, so as to turn off the power switch system control unit, reset the timer, and stop timing.
